(19) United States
(12) Patent Application Publication
(10) Pub. No.: US 2004/0070659 A1
(43) Pub. Date: Apr. 15, 2004

(54) Digital printing apparatus

(75) Inventor: Jacob Boo-Hee Lee, Tenafly, NJ (US)

Correspondence Address: John K. Kim, McCarter & English, Four Gateway Center, 100 Mulberry Street, Newark, NJ, 07102, US

(73) Assignee: Galaxy Colors, Inc.

(21) Appl. No.: 10/619,244

(22) Filed: Jul. 14, 2003

Related U.S. Application Data
(60) Provisional application No. 60/395,957, filed on Jul. 15, 2002.

(51) Int. Cl. B41J 29/13

(52) U.S. Cl. 347/108

(57) ABSTRACT

Printing apparatus includes print heads which are covered by a cover mechanism when the print heads are not in use. The cover mechanism is adapted to create a moist environment around the print heads saturated with vapors of an associated solvent. The printing apparatus also includes a purging system for the print heads. The purging system is adapted to cause the print heads to discharge a high-velocity stream of ink therethrough in response to selective manual actuation.

### CROSS-REFERENCE TO RELATED APPLICATION

This is a nonprovisional application relating to U.S. Provisional Application No. 60/395,957 filed Jul. 15, 2002.

### FIELD OF THE INVENTION

The present invention relates to digital printing apparatus and, more particularly, to a solvent based ink-jet digital printer adapted for use in generating large signs, banners or the like.

### BACKGROUND OF THE INVENTION

Solvent-based wide-format or grand-format ink-jet printers have been used in the past for generating professional grade, large or wide indoor/outdoor signs and banners, such as billboard-sized advertisements and building murals. For instance, Nur America, Inc. and Vutek, Inc. have marketed this type of printer under the trademarks “BLUEBOARD”, “FESCO” and “SALSA” and the trademarks “ULTRAVU” and “PRESSVU”, respectively.

The type of printer mentioned above typically includes a print head assembly having an array of print heads for applying inks onto print media. In operation, the print head assembly moves across the print media and applies inks through spray or discharge holes provided in the print heads onto the media.

The printers discussed above use solvent-based inks, which tend to dry up relatively quickly. As a result, when print heads are left in non-printing mode (e.g., the printer is in waiting or suspension mode) for an extended period of time, inks remaining in the spray holes of the print heads tend to clot, hence clogging the spray holes and causing malfunctioning. When the print heads become clogged, they need to be unclogged manually or be replaced and thereby render their operation and maintenance inefficient and costly.

In order to keep inks from clotting, some printers are programmed to periodically discharge inks through their print heads. However, these printers waste a large of inks, which are expensive.

### SUMMARY OF THE INVENTION

The present invention overcomes the disadvantages and shortcomings discussed above by providing an improved printing apparatus adapted to inhibit inks from clotting in print heads. In accordance with one feature of the present invention, the print heads are covered by a cover mechanism when they are not in use. The cover mechanism is adapted to create a moist environment around the print heads substantially saturated with vapors of an associated solvent.

Another feature of the present invention involves providing a purging system for the print heads. More particularly, the purging system is adapted to cause the print heads to discharge a high-velocity stream of ink therethrough in response to selective manual actuation.

### DESCRIPTION OF THE DRAWINGS

For a more complete understanding of the present invention, reference is made to the following detailed description of the present invention considered in conjunction with the accompanying drawings, in which:

FIG. 1 is a perspective view of a digital printer constructed in accordance with the present invention;

FIG. 2 is a simplified cross-sectional view of the digital printer shown in FIG. 1;

FIG. 3 is a perspective view of a print head-sleeping station and a print head-purging station of the digital printer shown in FIGS. 1 and 2;

FIG. 4 is an exploded perspective view of the head-sleeping station shown in FIG. 3;

FIG. 5 is a perspective view of the head-sleeping station shown in FIGS. 3 and 4, looking from a certain direction;

FIG. 6 is a perspective view of the head-sleeping station shown in FIGS. 3-5, looking from another direction;

FIGS. 7A-7E are schematic views of the head-sleeping station shown in FIGS. 3-6, illustrating its operation;

FIG. 8 is a partial cross-sectional view of the head-sleeping station shown in FIG. 7D;

FIG. 9 is a perspective view of the head-purging station shown in FIG. 3;

FIG. 10 is a view similar to FIG. 9, except that an associated print head assembly is positioned in the head-purging station;

FIG. 11 is a perspective view of an ink supply bottle utilized by the printer shown in FIG. 1;

FIG. 12 is a schematic view of a head-purging system of the printer shown in FIG. 1; and

FIG. 13 is a schematic view of a valve actuator of the head-purging system shown in FIG. 12.

### DETAILED DESCRIPTION OF THE INVENTION

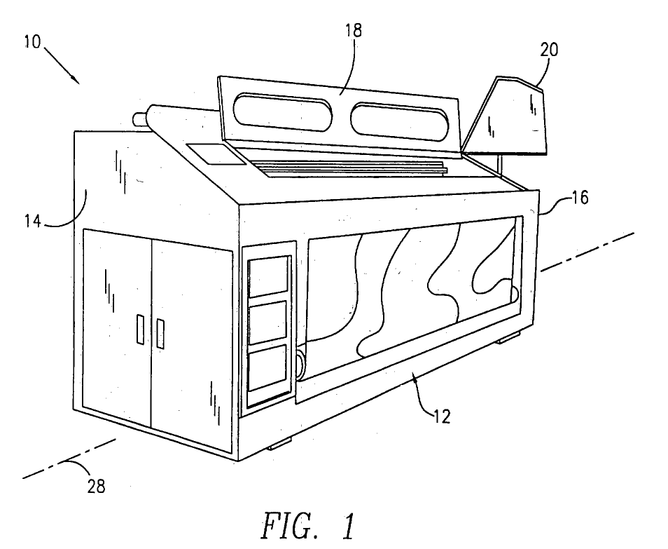

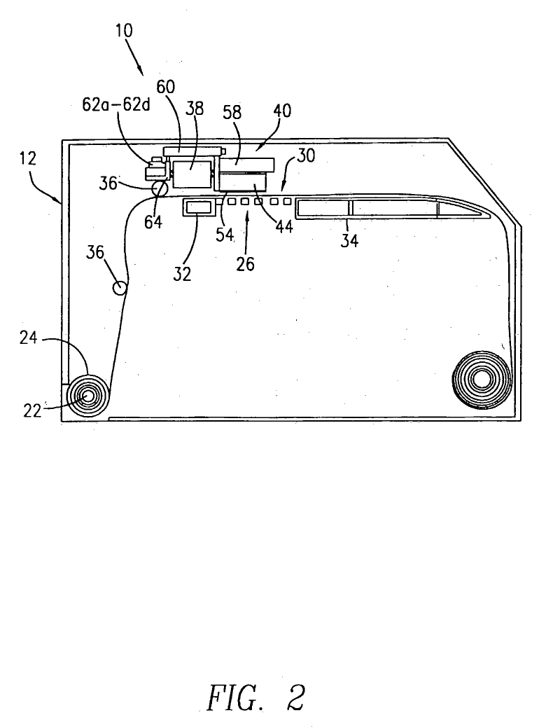

With reference to FIGS. 1 and 2, there is shown a digital printer 10 constructed in accordance with the present invention. More particularly, the printer 10 includes a housing 12 having a construction similar to that of the conventional printers discussed above. The housing 12 has a pair of sides 14, 16 and access panels 18, 20 for accessing an interior of the housing 12. The printer 10 is also equipped with various conventional components for performing a printing operation (i.e., printing images onto print media). For instance, a supply roller 22 for is provided on the housing 12 for rotatably mounting a roll of print media 24 (e.g., PCV vinyl flexes, vinyl meshes, self-adhesive vinyl materials, papers and fabrics) on the housing 12. A slotted bed 26 is also mounted in the housing 12 and extends in a direction substantially parallel to a longitudinal axis 28 (see FIG. 1) of the housing 12, defining a printing area 30 of the printer 10 (i.e., an area through which the print media 24 is fed for a printing operation). A media-holding bed 32 and a media dryer bed 34 interpose the slotted bed 26 therebetween. Feeding rollers 36 are also provided on the housing 12 for properly feeding the print media 24 through the printing area 30.

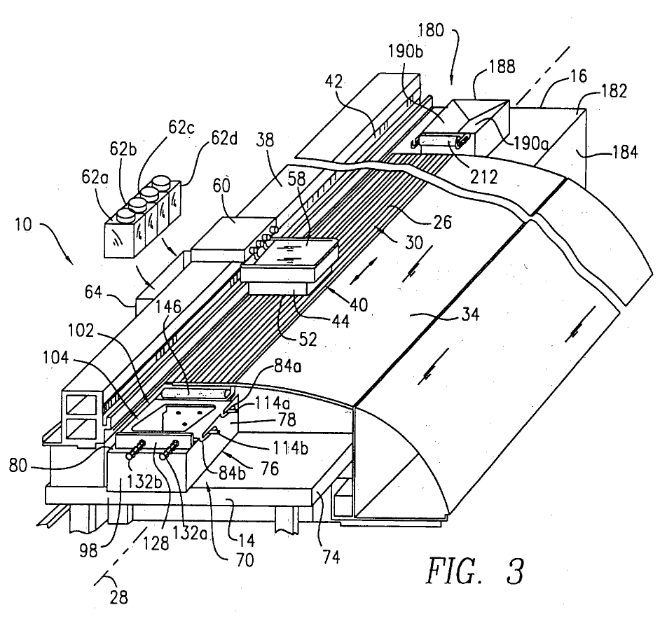

Now referring to FIGS. 2 and 3, the printer 10 also includes a rail 38 mounted within the housing 12. More particularly, the rail 38 extends in the longitudinal direction (i.e., in a direction parallel to the longitudinal axis 28 of the housing 12) between the sides 14, 16 of the housing 12 above the media holding bed 32. A print head assembly 40 is movably mounted to the rail 38 in a conventional manner. As a result, the print head assembly 40 is adapted to move across the printing area 30 for performing a printing function in a conventional manner. In this regard, a belt 42 is attached to the print head assembly 40 for moving same along the rail 38.

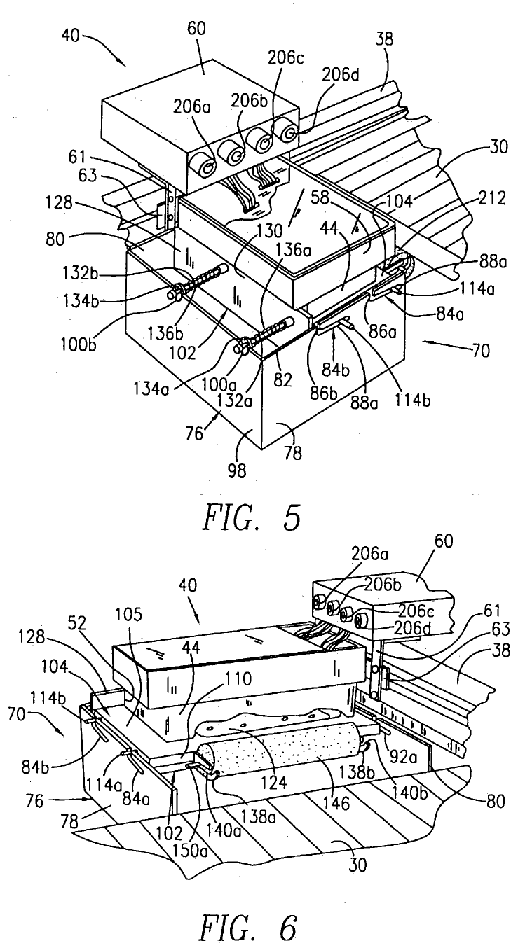

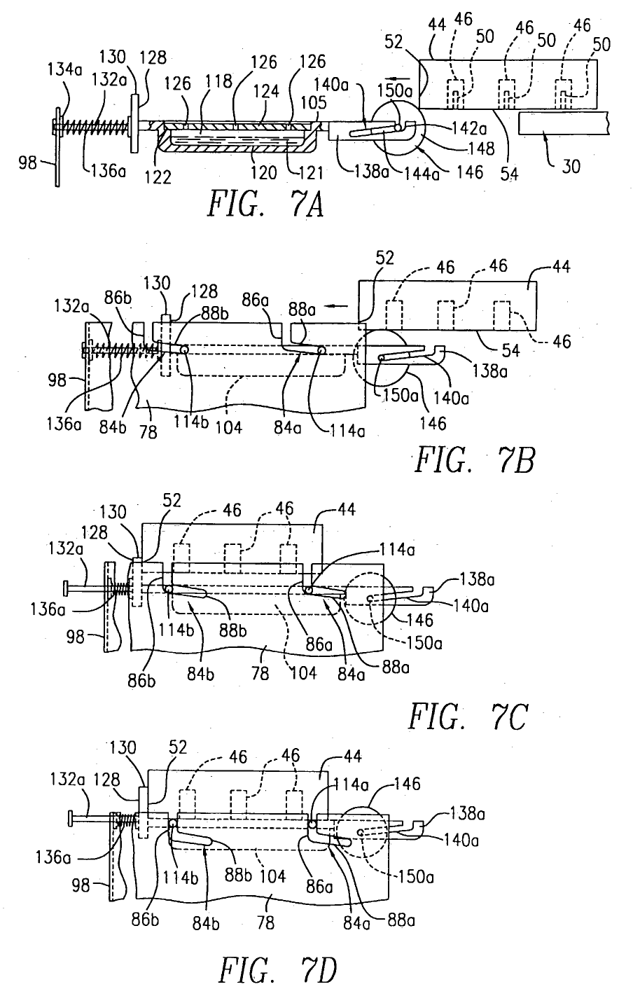

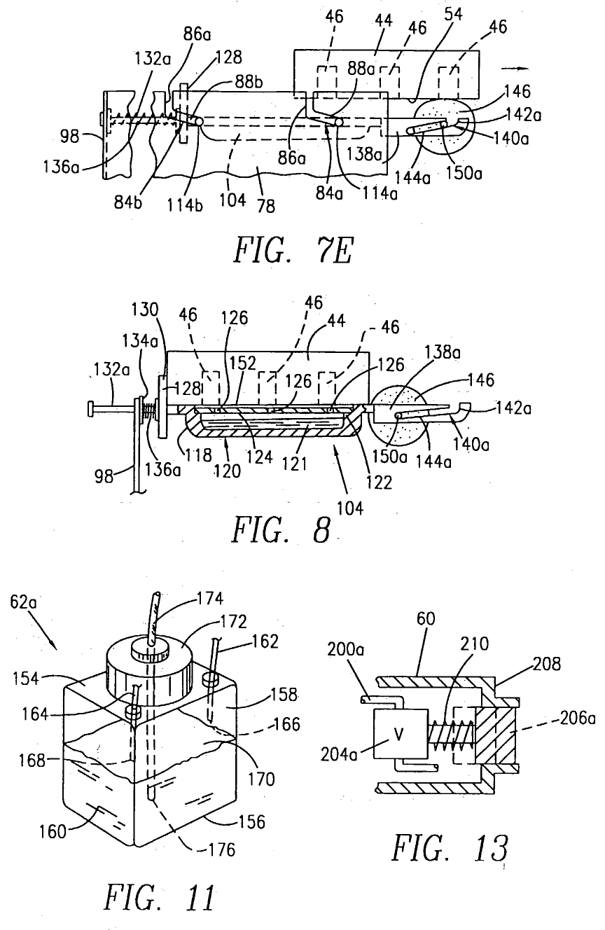

With reference to FIGS. 1-4, the print head assembly 40 is also equipped with a print head case 44 sized and shaped for housing conventional print head components, such as print heads 46 and electronic devices (not shown) for controlling the operation of the print heads 46. Each of the print heads 46 has a spray end 48 having a plurality of spray or discharge holes 50 (see FIG. 7A) for spraying inks therethrough. The case 44 includes a bottom edge 52 and a lower panel 54 having an array of openings 56 for receiving the spraying ends 48 of the print heads 46. A cover 58 is removably attached to the print head case 44. The print head assembly 40 also includes a valve housing 60 for movement along with the case 44 for purposes to be discussed hereinafter. The print head case 44, the print head cover 58 and the valve housing 60 are attached to one another as an assembly by brackets 61 and a mounting plate 63 (see FIGS. 5 and 6).

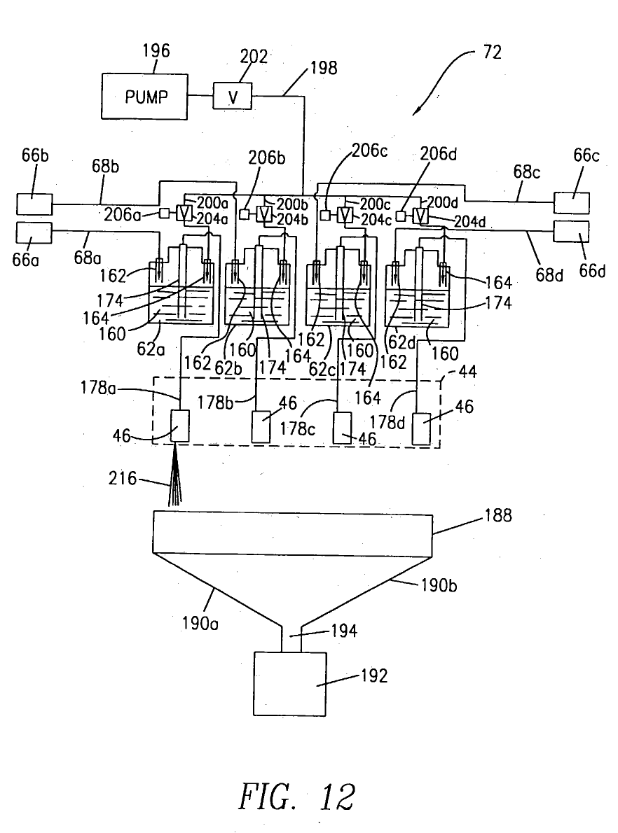

Referring to FIG. 3, ink bottles 62a-62d are removably mounted on the print head assembly 40. In this regard, a cradle 64 is located at a rear side of the print head assembly 40 for carrying the ink bottles 62a-62d thereon. Each of the ink bottles 62a-62d contains a supply of ink and is connected to a corresponding one or set of the print heads 46 in a conventional manner for supplying ink thereto during a printing operation. As is conventional, ink containers 66a-66d (see FIG. 12) are located in the housing 12 remote from the print head assembly 40 and are connected to the ink bottles 62a-62d, respectively, via supply lines 68a-68d, respectively, for conveying inks thereto.

The printer 10 of the present invention is equipped with a print head-sleeping station 70 (see FIG. 3) and a print head-purging system 72 (see FIG. 12). Briefly, the head-sleeping station 70 provides the print heads 46 with a “moist” environment so as to inhibit ink from clotting and hence clogging the spray holes 50 of the print heads 46 during an extended period of non-use. The head-purging system 72 is adapted to remove debris, such as clotted ink from the spray holes 50 of the print heads 46. The construction and operation of the head-sleeping station 70 and the head-purging system 72 will be discussed in detail hereinbelow.

The Head-Sleeping Station

With reference to FIGS. 3-6, the head-sleeping station 70 is positioned adjacent to the side 14 of the housing 12. More particularly, the head-sleeping station 70 includes a substantially horizontal support panel 74 and a support frame 76 fixedly mounted on the support panel 74. The frame 76 is provided with a pair of side panels 78, 80 extending in the longitudinal direction (i.e., in a direction substantially parallel to the longitudinal axis 28 of the housing 12). The panel 78 has an upper end 82 and tracks 84a, 84b formed in the side panel 78 adjacent the upper end 82 and spaced from one another. More particularly, the tracks 84a, 84b include vertical track sections 86a, 86b formed in the upper end 82 and oriented in a vertical direction. Slanted track sections 88a, 88b extend from the vertical track sections 86a, 86b, respectively, in a generally downward direction toward the side 16 of the housing 12 for purposes to be discussed hereinafter.

Like the side panel 78, the side panel 80 has an upper end 90 and tracks 92a, 92b formed in the side panel 80 adjacent the upper end 90 and spaced from one another. More particularly, the tracks 92a, 92b include vertical track sections 94a, 94b, respectively, formed in the upper end 90 and oriented in a vertical direction. Slanted track sections 96a, 96b extend from lower ends of the vertical track sections 94a, 94b, respectively, in a generally downward direction toward the side 16 of the housing 12 for purposes to be discussed hereinafter.

The frame 76 also includes an end panel 98 connected to the side panels 78, 80 for reinforcing the side panels 78, 80. More particularly, the end panel 98 is oriented in a direction substantially transverse to the longitudinal axis 28 of the housing 12 (referred to hereinafter “the transverse direction”). The end panel 98 is also provided with a pair of openings 100a, 100b for purposes to be discussed hereinafter.

The head-sleeping station 70 also includes a print head cover assembly 102 movably mounted on the frame 76 (see FIGS. 3-6). More particularly, the cover assembly 102 includes a cover plate 104 having an upper surface 105, a pair of longitudinal sides 106, 108, which extend along the longitudinal direction, and a pair of lateral sides 110, 112, which extend along the transverse direction. Guide pins 114a, 114b and guide pins 116a, 116b project outwardly from the longitudinal sides 106, 108, respectively. The guide pins 114a, 114b are received in the tracks 84a, 84b, respectively, of the side panel 78 such that they are movable along the entire length of the tracks 84a, 84b, respectively. Likewise, the tracks 116a, 116b are received in the tracks 92a, 92b, respectively, of the side panel 80 such that they are movable along the entire length of the tracks 92a, 92b, respectively. In this manner, the cover assembly 102 is movable from an extended position (see FIG. 7B) to a retracted position (see FIG. 7C) and then to a closing position (see FIG. 7D) and vice versa, as will be discussed in greater detail hereinafter.

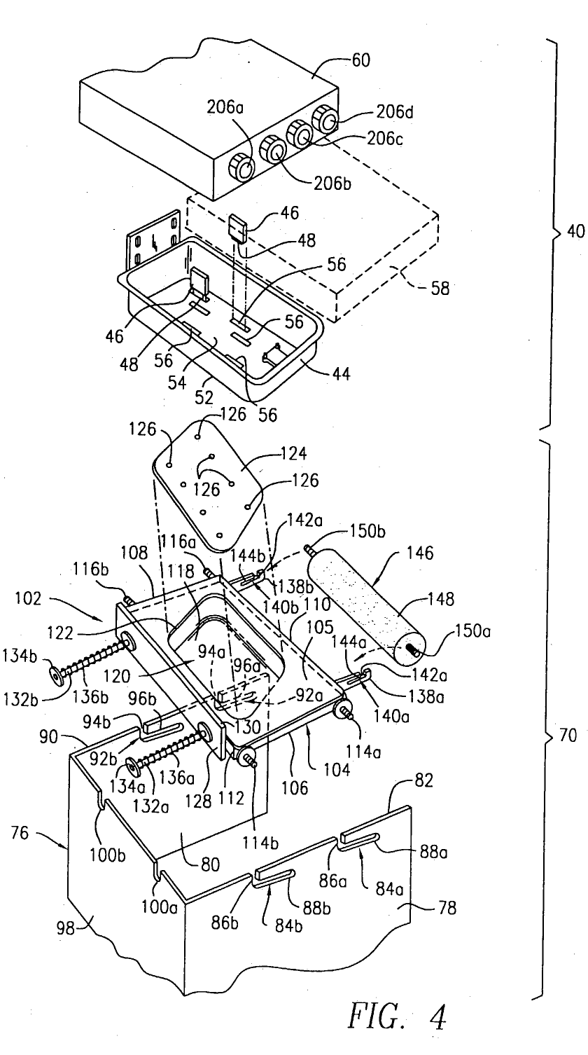

With reference to FIGS. 4 and 8, the cover plate 104 has a depression 118 so as to form a basin 120 for holding a solvent 121 therein. The basin 120 is equipped with a ledge 122 along an upper end thereof. A plate-like screen member 124 is removably mounted on the ledge 122 and is provided with a plurality of holes 126. The ledge 122 is positioned below the upper surface 105 of the cover plate 104 such that the screen member 124 is located below the upper surface 105 of the cover plate 104. The cover plate 104 is magnetized for purposes to be discussed hereinafter.

Now referring to FIGS. 3-7A and 8, a contact plate 128 is fixedly mounted to the lateral side 112 of the cover plate 104. More particularly, the contact plate 128 has an upper portion 130 projecting substantially upwardly from the contact plate 128. Guide rods 132a, 132b extend from the contact plate 128 in the longitudinal direction toward the side 14 of the housing 12. The guide rods 132a, 132b are movably received in the openings 100a, 100b, respectively, of the end panel 98. More particularly, the guide rods 132a, 132b are slidable through the openings 100a, 100b, respectively, in the longitudinal direction and are movable in the openings 100a, 100b, respectively, in the vertical direction. Washers 134a, 134b are loaded on the guide rods 132a, 132b, respectively, and are positioned on an interior side of the end panel 98. A spring member 136a is mounted on the guide rod 132a between the washer 134a and the contact plate 128, while a spring member 136b is loaded on the guide rod 132b between the washer 134b and the contact plate 128. In this manner, the springs 136a, 136b are adapted to urge the cover plate 104 toward its extended position (see FIGS. 7A and 7B).

With reference to FIGS. 4, 6 and 7A, holders 138a, 138b extend from the lateral side 110 of the cover plate 104 toward the side 16 of the housing 12 and include tracks 140a, 140b, respectively. More particularly, the tracks 140a, 140b are provided with vertical track sections 142a, 142b, respectively formed in the holders 138a, 138b, respectively, and extending in the vertical direction. The tracks 140a, 140b are also equipped with slanted track sections 144a, 144b, respectively, extending from lower ends of the vertical track sections 142a, 142b, respectively, in a generally downward direction toward the side 14 of the housing 12.

A wiping roller 146 is movably mounted on the holders 138a, 138b of the cover assembly 102 (see FIGS. 4, 6 and 7A). The wiping roller 146 has a substantially cylindrical wiping surface 148 and a pair of pins 150a, 150b (see FIG. 4) extending therefrom in the transverse direction. The pins 150a, 150b are movably received in the tracks 140a, 140b, respectively, of the holders 138a, 138b, respectively. As a result, the wiping roller 146 is movable between a retracted position (see FIG. 7C), in which it is located adjacent to the cover plate 104, and an extended position (see FIG. 7A), in which it is located remote from the cover plate 104. Because of the downward orientation of the slanted track sections 144a, 144b, the wiping roller 146 at its extended position is located at a vertical position that is higher than that of the wiping roller 146 at its retracted position for purposes to be discussed hereinafter.

The printer 10 is programmed such that the print head assembly 102 is put in a “sleeping” mode when it is not in use for a predetermined period of time. That is, the print head assembly 102 is caused to move into the head-sleeping station 70. As the print head assembly 102 moves from the printing area 30 into the head-sleeping station 70, the lower panel 54 of the print head case 44 engages the wiping roller 146 positioned in its extended position (see FIG. 7A). As the print head assembly 102 moves further into the head-sleeping station 70, the wiping roller 146 is caused by the print head case 44 to move into its retracted position (see FIG. 7B). In this manner, the print head assembly 102 can move into the head-sleeping station 70 without firmly engaging the wiping roller 146. The wiping roller 146 remains in its retracted position until the print head assembly 40 moves out of the head-sleeping station 70.

With reference to FIG. 7C, as the print head assembly 40 moves further toward the side 14 of the housing 12, the bottom edge 52 of the print head case 44 comes in contact with the contact plate 128 of the cover assembly 102 and causes the cover assembly 102 to move from its extended position to its retracted position. When the cover assembly 102 is positioned in its retracted position (see FIG. 7C), the guide pins 114a, 114b, 116a, 116b are aligned with the vertical track sections 86a, 86b, 94a, 94b, respectively, of the tracks 84a, 84b, 92a, 92b, respectively. Because the cover plate 104 is magnetized and the print head case 44 is made from an iron-based material (such as stainless steel), the cover plate 104 is caused to move upwardly toward the print head case 44 into its closing position (see FIG. 7D). Due to their vertical orientation, the vertical track sections 86a, 86b, 94a, 94b permit movement of the cover assembly 102 in the vertical direction.

With reference to FIGS. 7D and 8, when the cover assembly 102 is in its closing position, the cover plate 104 is in tight engagement with the print head case 44 such that the print heads 46 are covered by the cover plate 104. Due to the tight engagement formed between the cover plate 104 and the print head case 44, a substantially air-tight seal is created around the basin 120 of the cover plate 104. In this manner, vapors of the solvent 121 contained in the basin 120 are permitted to permeate into a space 152 (see FIG. 8), which is formed below the print heads 46 and sealed by the cover plate 104, through the holes 126 of the screen member 124, hence creating a “moist” environment around the print heads 46. As a result, solvent-based inks remaining in the spray holes 50 of the print heads 46 are inhibited from clotting or drying out. The screen member 124 inhibits the solvent 121 contained in the basin 120 from splashing during its movement, while permitting vapors to permeate into the space 152 through the holes 126.

When the print head assembly 102 goes into a “print” mode or “purging” mode, it moves out from the head-sleeping station 70. More particularly, with the print head assembly 40 engaged with the cover plate 104, it moves toward the printing area 30, sliding along the upper surface 105 of the cover plate 104. Because the guide pins 114a, 114b, 116a, 116b of the cover plate 104 are positioned in the vertical track sections 86a, 86b, 94a, 94b, respectively, of the support frame 76, the cover plate 104 remains stationary until it is disengaged from the print head case 44. When the cover plate 104 disengages from the print head case 42, it is caused to move downwardly by gravity into its retracted position (see FIG. 7C). Because of the force applied by the contracted springs 136a, 136b, the cover plate 104 moves into its extended position (see FIG. 7E).

During its exit from the head-sleeping station 70, the lower panel 54 of the print head case 44 loosely engages the wiping roller 146 oriented in its retracted position. As the print head case 44 moves toward the printing area 30, it causes the wiping roller 146 to move to its extended position (see FIG. 7E). In its extended position, the wiping roller 146 rotatably and firmly engages the lower panel 54 of the print head case 44, including the spray ends 48 of the print heads 46 so as to wipe off excess inks or condensed solvent therefrom.

It should be noted that the head-sleeping station 70 of the present invention provides numerous advantages over the prior art discussed above. Because the print heads 46 are automatically covered by the cover plate 104 when they are in their sleeping mode, they are kept “moist”. As a result, the spray holes 50 of the print heads 46 are inhibited from clogging even if the print head assembly 40 remains in its sleeping mode for an extended period of time.

It should be noted that the head-sleeping station 70 of the present invention can have numerous variations and modifications. For instance, the cover assembly 102 can be moved upwardly from its retracted position to its closing position by different mechanisms (e.g., a spring loaded urging mechanism mounted below or above the cover assembly 102). Moreover, the spring/rod mechanism of the cover assembly 102 (e.g., the springs 136a, 136b and the rods 132a, 132b) can be modified or replaced by a number of different mechanisms, such as a motorized system. The wiping roller 146 can be provided with a spring-loaded mechanism for causing same to move between its retracted and extended positions.

The Head-Purging System

The head-purging system 72 (see FIG. 12) is adapted to perform a head-purging operation (i.e., causing a high-velocity stream of ink to flow through the spray holes 50 of the print heads 46) by selectively pressurizing the ink bottles 62a-62d. In such circumstance, the construction of the ink bottles 62a-62d will be discussed hereinbelow, followed by a discussion of other components of the head-purging system 72.

The ink bottles 62a-62d have a construction identical to one another. In such circumstances, only the construction of the ink bottle 62a will be discussed herein. Referring to FIGS. 11 and 12, the ink bottle 62a has a top 154 and a bottom 156 and an interior chamber 158 for holding ink 160 therein. An ink supply tube 162 and an air supply tube 164 extend from the exterior of the ink bottle 62a into the chamber 158. The ink supply tube 162 and the air supply tube 164 have ends 166, 168, respectively, positioned in the chamber 158 adjacent the top 154 thereof such that the ends 166, 168 are located above an upper surface 170 of the ink 160 contained in the ink bottle 62a. Air-tight seals are formed between the ink supply tube 162 and the ink bottle 62a and between the air supply tube 164 and the ink bottle 62a. A cap 172 is removable mounted to the top 154 of the ink bottle 62a in an air-tight manner. The cap 172 has an outlet tube 174 extending from the exterior of the ink bottle 62a into the chamber 158 through the cap 172. The outlet tube 174 has an end 176 positioned adjacent the bottom 156 of the ink bottle 62a such that the end 176 is constantly submerged in the ink 160.

With reference to FIG. 12, the supply lines 68a-68d are connected to the ink supply tubes 162 of the ink bottles 62a-62d, respectively, for conveying inks thereto from the ink containers 66a-66d, respectively. Moreover, the outlet tubes 174 of the ink bottles 62a-62d are connected to the print heads 46 via supply lines 178a-178d, respectively, for supplying inks to the print heads 46, from the ink bottles 62a-62d, respectively.

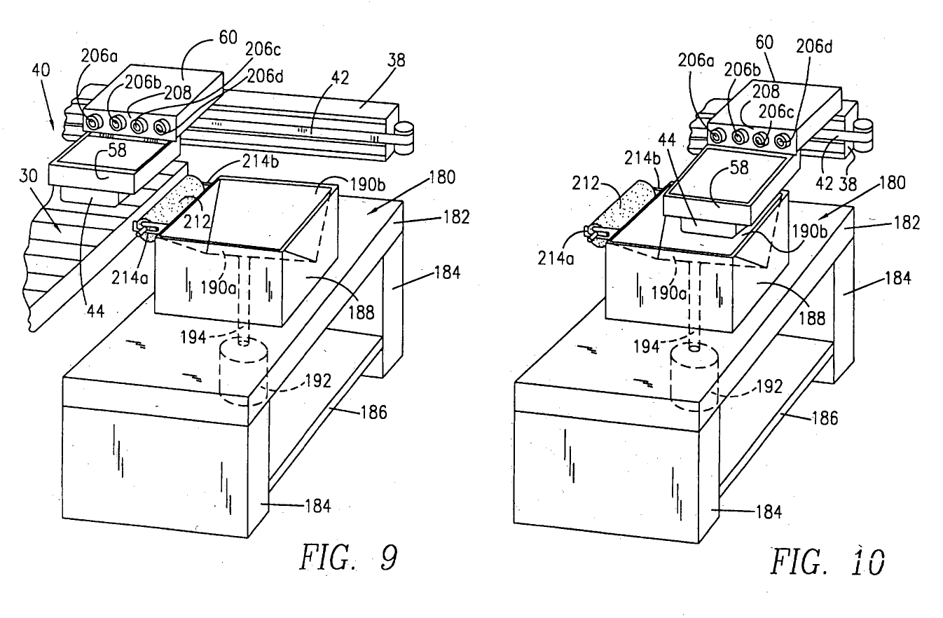

Now referring to FIGS. 3, 9, 10 and 12, the head-purging system 72 also includes a purging station 180 located adjacent the side 16 of the housing 12. The purging station 180 has an upper table 182 and support members 184 for supporting the upper table 182. A lower table 186 is supported by the support members 184 below the upper table 182. A collection pan 188 is placed on the upper table 182 and includes a pair of sloped or funneled sides 190a, 190b, while a collection bottle 192 is positioned on the lower table 186. A tube 194 extends from a lower end of the collection pan 188 to the collection bottle 192 through the upper table 182 for purposes to be discussed hereinafter.

With reference to FIG. 12, the head-purging system 72 is also equipped with a pressurized air source 196 (e.g., a pump such as the pumps sold by Flojet Corporation under model no. ET 200B). A supply line 198 is connected to the pump 196 for supplying pressurized air from the pump 196 to the ink bottles 62a-62d. In this regard, the supply line 198 branches into branch lines 200a-200d connected to the air supply tubes 164 of the ink bottles 62a-62d, respectively. A pressure-relief valve 202 having a conventional construction is also provided in the supply line 198 so as to release excess pressure therefrom. More particularly, when the pressure in the supply line 198 exceeds a predetermined level, the pressure-relief valve 202 vents air from the supply line 198.

With reference to FIGS. 12 and 13, valves 204a-204d (e.g., valves sold by Pneumatic Division, Parker Hannifin plc, Bridgetown, U.K., under model no. PXB) are provided in the branch lines 200a-200d, respectively, for controlling flow of pressurized air therethrough from the pump 196 to the ink bottles 62a-62d, respectively. The valves 204a-204d are positioned in the valve housing 60 of the print head assembly 40 and include valve actuators 206a-206d, respectively, mounted to a front panel 208 of the valve housing 60. The valve actuators 206a-206d are adapted to independently and selectively cause the valves 204a-204d, respectively, to move between open positions, in which the valves 204a-204d permit pressurized air to pass therethrough from the pump 196 to the ink bottles 62a-62d, respectively, and closed positions, in which the valves 204a-204d prevent pressurized air from being conveyed to the ink bottles 62a-62d, respectively. In this regard, each of the valve actuators 206a-206d is movable between a depressed position (see the broken line representation of the valve actuator 206a in FIG. 13), in which a corresponding one of the valves 204a-204d is in its open position, and an extended position (see the solid line representation of the valve actuator 206a in FIG. 13), in which a corresponding one of the valves 204a-204d is in its closed position. An urging mechanism 210 (e.g., a coiled spring) is mounted on each of the valves 204a-204d for urging a corresponding one of the valve actuators 206a-206d to its extended position.

Like the head-sleeping station 70, the purging station 72 also has a wiping roller 212 mounted to the collection pan 188. Holders 214a, 214b extend from the collection pan 188 toward the printing area 30 of the printer 10. The wiping roller 212 is movably mounted on the holders 214a, 214b in a manner basically identical to the manner in which the wiping roller 146 of the head-sleeping station 70 is movably mounted on the holders 138a, 138b. As a result, the wiping roller 212 operates in the same basic manner as the wiping roller 146.

During the performance of a printing operation, an operator periodically performs a visual inspection of an image being printed on the print media 24 by the print head assembly 40. If the quality of the printed image is poor, the operator causes the printer 10 to initiate a head-purging operation by pressing an appropriate function key or keys provided on the printer 10 (e.g., by pressing a “pause” key to pause the printing operation and then a “purge” key to initiate the head-purging operation). When the head-purging operation is initiated, the print head assembly 40 moves into the head-purging station 72 from the printing area 30. The pump 196 is also activated from its deactivated state. As the print head assembly 40 moves into the head-purging station 72, the wiping roller 212 is caused to move into a retracted position in basically the same manner as the wiping roller 146 of the head-sleeping station 70. When the print head assembly 40 is positioned above the collection pan 188, the actuators 206a-206d are manually pressed by an operator in a selective manner, causing pressurized air to be supplied to the ink bottles 62a-62d, respectively, from the pump 196 through the supply line 196 and the branch lines 200a-200d, respectively. As a result, the ink bottles 62a-62d become independently and selectively pressurized. Due to the pressurization of the ink bottles 62a-62d, the inks 160 contained therein flow into the outlet tubes 174 and then are supplied to the print heads 46 through the supply lines 178a-178d, thereby creating a high velocity stream 216 of ink (see FIG. 12) through the spray holes 50 of the print heads 46. The discharged inks are collected in the collection pan 188 and then are conveyed to the collection bottle 192 through the tube 194.

After the performance of the head-purging operation, the operator causes the printer 10 to resume its printing operation by pressing an appropriate function key (e.g., an “escape” key) provided on the printer 10. In response, the print head assembly 40 moves out of the head-purging station 72 into the printing area 30. As the print head assembly 40 moves out of the head-purging station 72, the wiping roller 212 is caused to move into an extended position in basically the same manner as the wiping roller 146 of the head-sleeping station 70 so as to wipe off inks from the lower panel 54 of the print head case 44.

It should be appreciated that the head-purging system 72 of the present invention also provides numerous advantages. For instance, because a high velocity stream of ink can be independently and selectively passed through the spray holes 50 of the print heads 46, debris contained in the spray holes 50, including clotted or partially clotted inks, can be removed, hence enhancing the performance of the print heads 50.

It should be noted that the head-purging system 72 can have numerous modification and variations. For instance, one or more of the valve actuators 206a-206d can be modified so as to electrically or electronically actuate the valves 204a-204d, respectively. Further, the head-purging system 72 can be equipped with more than one pumps.

It will be understood that the embodiment described herein is merely exemplary and that a person skilled in the art may make many variations and modifications without departing from the spirit and scope of the invention. All such variations and modifications, including those discussed above, are intended to be included within the scope of the invention.

I claim:

1. Printing apparatus comprising at least one print head; and covering means for covering said at least one print head when said print head is not in use.
